(19) United States
(12) Patent Application Publication
(10) Pub. No.: US 2026/0254530 A1
(43) Pub. Date: Aug. 27, 2026

(54) POLARIZATION FLUCTUATION MONITORING APPARATUS, COMMUNICATION SYSTEM, AND POLARIZATION FLUCTUATION MONITORING METHOD

(71) Applicant: NEC Corporation, Tokyo (JP)

(72) Inventor: Yusuke SASAKI, Tokyo (JP)

(73) Assignee: NEC Corporation, Tokyo (JP)

(21) Appl. No.: 19/535,251

(22) Filed: Feb. 10, 2026

(30) Foreign Application Priority Data
Feb. 21, 2025 (JP) 2025-026565

(51) Int. Cl. H04B 10/079

(52) U.S. Cl. CPC H04B 10/07951

(57) ABSTRACT

A polarization fluctuation monitoring apparatus includes a polarization characteristic measurement unit for measuring polarization characteristics of a first monitoring signal transmitted in a first direction using a first core and a second monitoring signal transmitted in a second direction opposite to the first direction using a second core in a transmission path including a weakly-coupled multicore fiber including the first core and the second core, a fluctuation detection unit for detecting polarization fluctuation occurring in each of the first monitoring signal and the second monitoring signal in the weakly-coupled multicore fiber based on the measured polarization characteristics, and a position estimation unit for estimating a position where the polarization fluctuation occurred in the transmission path based on the detected polarization fluctuation.

### INCORPORATION BY REFERENCE

This application is based upon and claims the benefit of priority from Japanese patent application No. 2025-026565, filed on February 21, 2025, the disclosure of which is incorporated herein in its entirety by reference.

### TECHNICAL FIELD

The present disclosure relates to a polarization fluctuation monitoring apparatus, a communication system, and a polarization fluctuation monitoring method.

### BACKGROUND ART

As a related art, JP 8-136607 A discloses a power transmission line lightning strike point locating apparatus. In the power transmission line lightning strike point locating apparatus described in JP 8-136607 A, the composite overhead ground wire includes an optical fiber. An optical signal output from a measurement light source is transmitted from a first end portion to a second end portion of the composite overhead ground wire using a first optical fiber among the optical fibers included in the composite overhead ground wire. The transmitted optical signal is folded back at the second end portion, and is transmitted from the second end portion to the first end portion by using a second optical fiber among the optical fibers included in the composite overhead ground wire. At the second end portion, a photodetector detects an optical signal reciprocating on the composite overhead ground wire. A signal processing unit detects polarization fluctuation caused by a lightning strike in the detected optical signal.

### SUMMARY

In an optical communication system, polarization multiplexed digital coherent communication has been introduced in order to increase the capacity. In such an optical communication system, a reception unit estimates a polarization state and separates signals. However, if the State of polarization (SOP) variation is rapid and large, it will be difficult to adaptively compensate for the SOP variation, and the signals may not be correctly separated. As factors that cause the SOP variation, construction vibration, passing of a vehicle, an earthquake, wind, a lightning strike, and the like are considered.

In order to specify the cause of the polarization fluctuation and plan a measure for the polarization fluctuation, it is necessary to estimate or specify the position of the polarization fluctuation. In JP 8-136607 A, it is possible to specify a location where the polarization fluctuation has occurred, that is, a lightning strike point, from a time difference between the polarization fluctuation generated in the optical signal advancing in a first direction through a first optical fiber and the polarization fluctuation generated in the optical signal advancing in a second direction through a second optical fiber.

However, in JP 8-136607 A, different optical fibers are used for bidirectional transmission of optical signals. Since the first optical fiber and the second optical fiber are physically different optical fibers, it is considered that the polarization sensitivity of the first optical fiber is different from the polarization sensitivity of the second optical fiber. It is also conceivable that the first optical fiber and the second optical fiber have different transmission characteristics such as transmission loss. In that case, an error may occur at a location where the specified polarization fluctuation has occurred due to a difference in polarization sensitivity or transmission characteristics.

An example object of the present disclosure is to provide a polarization fluctuation monitoring apparatus, a communication system, and a polarization fluctuation monitoring method capable of accurately estimating a position where polarization fluctuation has occurred.

A polarization fluctuation monitoring apparatus according to a first example aspect of the present disclosure includes a polarization characteristic measurement unit for measuring polarization characteristics of a first monitoring signal transmitted in a first direction using a first core and a second monitoring signal transmitted in a second direction opposite to the first direction using a second core in a transmission path including a weakly-coupled multicore fiber including the first core and the second core, a fluctuation detection unit for detecting polarization fluctuation occurring in each of the first monitoring signal and the second monitoring signal in the weakly-coupled multicore fiber based on the measured polarization characteristics, and a position estimation unit for estimating a position where the polarization fluctuation occurred in the transmission path based on the detected polarization fluctuation.

A communication system according to a second example aspect of the present disclosure includes one or more transmitters, each of which transmits a main signal, a transmission path for transmitting one or more main signals transmitted from the one or more transmitters, optical receivers, each of which receives the one or more main signals transmitted through the transmission path, and a polarization fluctuation monitoring apparatus for monitoring a polarization fluctuation in the transmission path. The transmission path includes a weakly-coupled multicore fiber including a first core and a second core. The polarization fluctuation monitoring apparatus includes a polarization characteristic measurement unit for measuring polarization characteristics of a first monitoring signal transmitted in a first direction using the first core and a second monitoring signal transmitted in a second direction opposite to the first direction using the second core in the transmission path, a fluctuation detection unit for detecting polarization fluctuation occurring in the weakly-coupled multicore fiber based on the measured polarization characteristics, and a position estimation unit for estimating a position where the polarization fluctuation occurred in the transmission path based on the detected polarization fluctuation.

A polarization fluctuation monitoring method according to a third example aspect of the present disclosure includes measuring a polarization characteristics of a first monitoring signal transmitted in a first direction using a first core and a second monitoring signal transmitted in a second direction opposite to the first direction using a second core in a transmission path including a weakly-coupled multicore fiber including the first core and the second core, detecting polarization fluctuation occurring in the weakly-coupled multicore fiber based on the measured polarization characteristics, and estimating a position where the polarization fluctuation occurred in the transmission path based on the detected polarization fluctuation.

The polarization fluctuation monitoring apparatus, the polarization fluctuation monitoring system, and the polarization fluctuation monitoring method according to the present disclosure can accurately estimate the position where the polarization fluctuation has occurred.

### BRIEF DESCRIPTION OF THE DRAWINGS

The above and other aspects, features and advantages of the present disclosure will become more apparent from the following description of certain exemplary embodiments, taken in conjunction with the accompanying drawings, in which:

FIG. 1 is a block diagram illustrating a schematic configuration example of a communication system according to the present disclosure;

FIG. 2 is a block diagram illustrating a configuration example of a polarization fluctuation monitoring system including a polarization fluctuation monitoring apparatus according to the present disclosure;

FIG. 3 is a block diagram illustrating a configuration example of an optical fiber communication system to which the polarization fluctuation monitoring system can be applied;

FIG. 4 is a cross-sectional view illustrating an example of a cross-sectional structure of a weakly-coupled multicore fiber;

FIG. 5 is a cross-sectional view illustrating another example of a cross-sectional structure of a weakly-coupled multicore fiber;

FIG. 6 is a block diagram illustrating a configuration example of the optical fiber cable;

FIG. 7 is a flowchart illustrating an operation procedure of the polarization fluctuation monitoring apparatus;

FIG. 8 is a block diagram illustrating another configuration example of the polarization fluctuation monitoring system according to the present disclosure; and

FIG. 9 is a block diagram illustrating a configuration example of a computer device.

### EXAMPLE EMBODIMENT

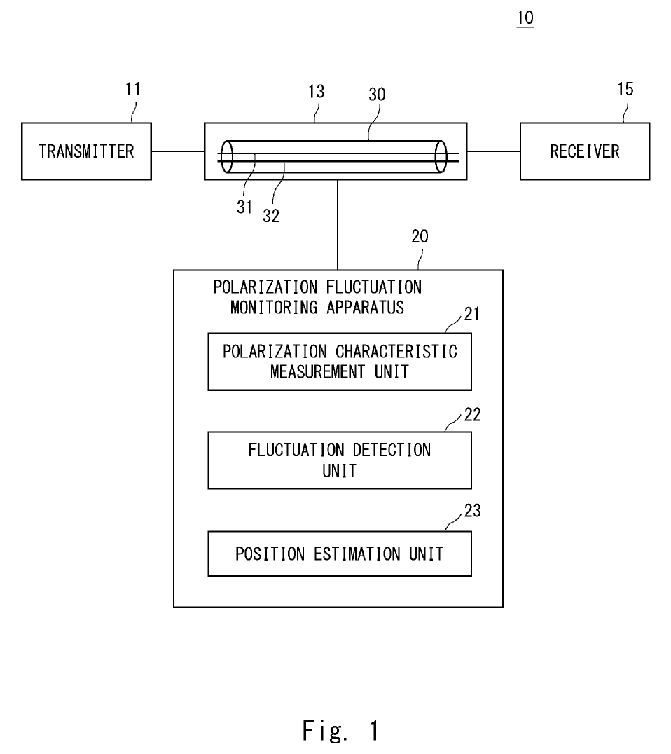

Prior to describing example embodiments of the present disclosure, an outline of the present disclosure will be described. FIG. 1 is a block diagram illustrating a schematic configuration example of a communication system according to the present disclosure. A communication system 10 includes one or more transmitters 11, a transmission path 13, one or more receivers 15, and a polarization fluctuation monitoring apparatus 20.

Each of the one or more transmitters 11 transmits a main signal. The transmission path 13 transmits one or more main signals transmitted from the one or more transmitters 11. The transmission path 13 includes a weakly-coupled multicore fiber 30. The weakly-coupled multicore fiber 30 includes a first core 31 and a second core 32. Here, the weakly-coupled multicore fiber can mean a multicore fiber in which there is no crosstalk between cores or the crosstalk between cores is negligibly small. Each of one or more receivers 15 receives one or more main signals transmitted via the transmission path 13. The polarization fluctuation monitoring apparatus 20 monitors the polarization fluctuation in the transmission path 13. Although FIG. 1 illustrates an example in which the transmitter 11 is disposed at one end portion of the transmission path 13 and the receiver 15 is disposed at the other end portion of the transmission path 13, the present disclosure is not limited thereto. The transmitter 11 and the receiver 15 may be disposed at both ends of the transmission path 13, and a signal transmitted and received between the transmitter 11 and the receiver 15 may be bidirectionally transmitted in the transmission path 13.

The polarization fluctuation monitoring apparatus includes a polarization characteristic measurement unit 21, a fluctuation detection unit 22, and a position estimation unit 23. In the transmission path 13, the polarization characteristic measurement unit 21 measures the polarization characteristics of a first monitoring signal transmitted in a first direction using the first core 31 and a second monitoring signal transmitted in a second direction opposite to the first direction using the second core 32. The fluctuation detection unit 22 detects the polarization fluctuation occurring in the weakly-coupled multicore fiber 30 based on the measured polarization characteristics. The position estimation unit 23 estimates the position where the polarization fluctuation has occurred in the transmission path 13 based on the detected polarization fluctuation.

In the present disclosure, the polarization characteristic measurement unit 21 measures the polarization characteristics of the first monitoring signal and the second monitoring signal transmitted bidirectionally using the first core 31 and the second core 32 of the weakly-coupled multicore fiber 30. In the present disclosure, the first monitoring signal and the second monitoring signal are bidirectionally transmitted using different cores of one weakly-coupled multicore fiber 30. In a case where the polarization fluctuation occurs in the weakly-coupled multicore fiber 30, it is considered that the same change in polarization state is observed in the first monitoring signal and the second monitoring signal. Therefore, the present disclosure can improve accuracy of an estimated position as compared with a case where a monitoring signal is bidirectionally transmitted using separate optical fibers.

Hereinafter, example embodiments according to the present disclosure will be described in detail. In the following description and drawings, omission and simplification are made as appropriate for clarity of description. In each drawing, the same elements and the similar elements are denoted by the same reference numerals, and the repeated description is omitted as necessary.

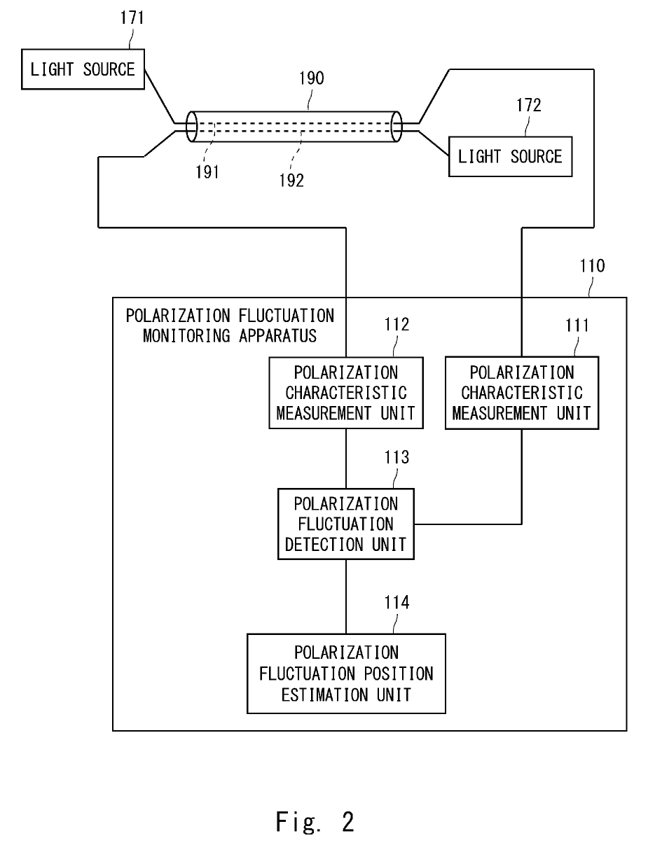

A first example embodiment of the present disclosure will be described. FIG. 2 is a block diagram illustrating a configuration example of a polarization fluctuation monitoring system including a polarization fluctuation monitoring apparatus according to the present disclosure. A first example embodiment will be described with reference to FIG. 2. The polarization fluctuation monitoring system 100 includes a polarization fluctuation monitoring apparatus 110, a light source 171, a light source 172, and a weakly-coupled multicore fiber 190. The polarization fluctuation monitoring apparatus 110 includes polarization characteristic measurement units 111 and 112, a polarization fluctuation detection unit 113, and a polarization fluctuation position estimation unit 114. Then, at least some of the functions of each of the units mounted in the polarization fluctuation monitoring apparatus 110 may be implemented by one or more processors operating in accordance with a program read from one or more memories. The polarization fluctuation monitoring apparatus 110 may include a programmable logic device such as a Field-Programmable Gate Array (FPGA), and at least some of the functions of each of the units of the polarization fluctuation monitoring apparatus 110 may be implemented by the FPGA. The polarization fluctuation monitoring apparatus 110 corresponds to the polarization fluctuation monitoring apparatus 20 illustrated in FIG. 1.

Each of the light sources 171 and 172 outputs a monitoring signal having a predetermined wavelength. For example, each of the light sources 171 and 172 outputs an optical signal having a wavelength of 1510 nm as a monitoring signal. The light source 171 is disposed at a first end portion of the weakly-coupled multicore fiber 190, and the light source 172 is disposed at a second end portion of the weakly-coupled multicore fiber 190. The light source 171 is also referred to as a first light source, and the light source 172 is also referred to as a second light source. Furthermore, the monitoring signal output from the first light source 171 is also referred to as a first monitoring signal, and the monitoring signal output from the second light source 172 is also referred to as a second monitoring signal.

The weakly-coupled multicore fiber 190 is a Multi Core Fiber (MCF) including a first core 191 and a second core 192. The weakly-coupled multicore fiber is also called a Weakly-Coupled multicore fiber (Weakly-Coupled MCF). The weakly-coupled multicore fiber 190 only needs to include two or more cores, and the number of cores in the weakly-coupled multicore fiber 190 is not limited to two. At the first end portion of the weakly-coupled multicore fiber 190, the first monitoring signal is input to the first core 191 using a Fan-In Fan-Out (FIFO) device or the like. At the second end portion of the weakly-coupled multicore fiber 190, the second monitoring signal is input to the second core 192 of the weakly-coupled multicore fiber 190 using the FIFO device or the like. The weakly-coupled multicore fiber 190 corresponds to the weakly-coupled multicore fiber 30 illustrated in FIG. 1. The first core 191 corresponds to the first core 31 illustrated in FIG. 1. The second core 192 corresponds to the second core 32 illustrated in FIG. 1.

The polarization characteristic measurement units 111 and 112 each receive the first monitoring signal and the second monitoring signal transmitted through the weakly-coupled multicore fiber 190. The polarization characteristic measurement unit 111 is also referred to as a first polarization characteristic acquisition unit, and the polarization characteristic measurement unit 112 is also referred to as a second polarization characteristic measurement unit. In the present example embodiment, the first polarization characteristic measurement unit 111 is disposed at the second end portion of the weakly-coupled multicore fiber 190 and receives the first monitoring signal transmitted in the first direction through the weakly-coupled multicore fiber 190. The second polarization characteristic measurement unit 112 is disposed at the first end portion of the weakly-coupled multicore fiber 190 and receives the second monitoring signal transmitted in the second direction opposite to the first direction through the weakly-coupled multicore fiber 190. In the first and second monitoring signals, polarization fluctuation may occur during transmission through the weakly-coupled multicore fiber 190.

Each of the polarization characteristic measurement units 111 and 112 includes, for example, a polarimeter. Each of the polarization characteristic measurement units 111 and 112 may include, for example, a polarizer and a photodetector. The first polarization characteristic measurement unit 111 calculates, for example, a Stokes parameter for the first monitoring signal. The second polarization characteristic measurement unit 112 calculates, for example, a Stokes parameter for the second monitoring signal. For example, each of the first polarization characteristic measurement unit 111 and the second polarization characteristic measurement unit 112 calculates the Stokes parameter S1 associated with the difference between the horizontal component and the vertical component of the linearly polarized light. The Stokes parameter calculated by the first polarization characteristic measurement unit 111 and the Stokes parameter calculated by the second polarization characteristic measurement unit 112 are each converted into a digital signal using an analog-to-digital converter and input to the polarization fluctuation detection unit 113. The polarization characteristic measurement units 111 and 112 correspond to the polarization characteristic measurement unit 21 illustrated in FIG. 1.

The polarization fluctuation detection unit 113 detects the polarization fluctuation occurring in each of the first monitoring signal and the second monitoring signal in the weakly-coupled multicore fiber 190 based on the measurement results of the polarization characteristics in the polarization characteristic measurement units 111 and 112. The polarization fluctuation detection unit 113 detects a first polarization fluctuation that occurred in the weakly-coupled multicore fiber 190 while the first monitoring signal is being transmitted in the first direction and a second polarization fluctuation that occurred in the weakly-coupled multicore fiber 190 while the second monitoring signal is being transmitted in the second direction. The polarization fluctuation detection unit 113 corresponds to the fluctuation detection unit 22 illustrated in FIG. 1.

The polarization fluctuation position estimation unit 114 estimates the position where the polarization fluctuation occurred in the weakly-coupled multicore fiber 190 based on the first polarization fluctuation detected in the first monitoring signal and the second polarization fluctuation detected in the second monitoring signal. The polarization fluctuation position estimation unit 114 estimates the position where the polarization fluctuation occurred in the weakly-coupled multicore fiber 190 based on, for example, a time difference between the time at which the first polarization fluctuation is detected and the time at which the second polarization state is detected. The polarization fluctuation position estimation unit 114 corresponds to the position estimation unit 23 illustrated in FIG. 1.

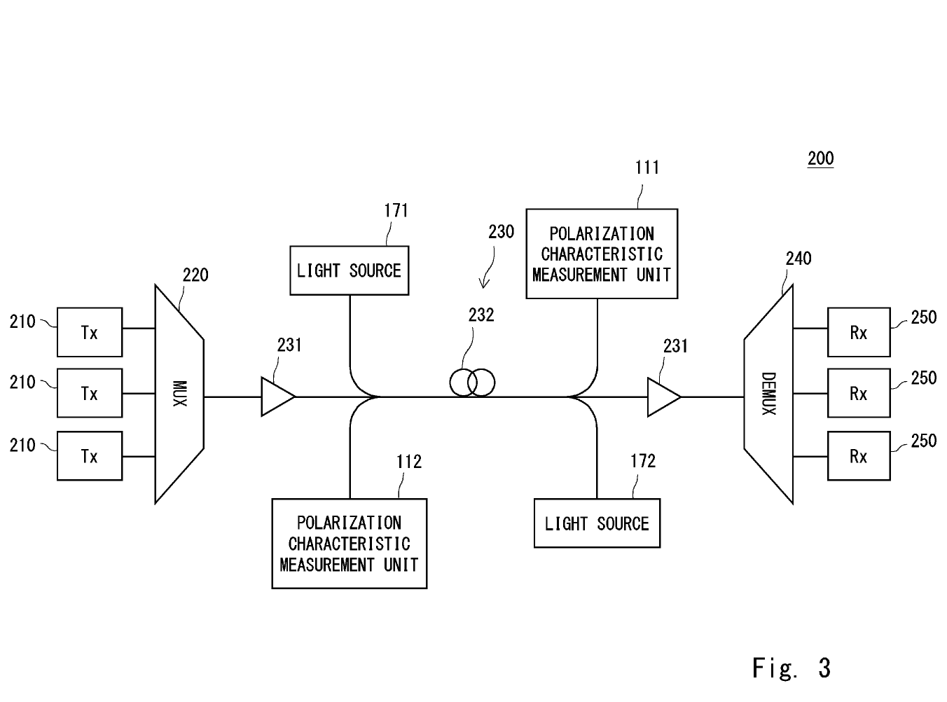

FIG. 3 is a block diagram illustrating a configuration example of an optical fiber communication system to which the polarization fluctuation monitoring system 100 can be applied. The optical fiber communication system 200 adopts, for example, a polarization multiplexed multi-value modulation system, and is configured as an optical fiber communication system that performs coherent reception. In addition, the optical fiber communication system 200 is assumed to be a communication system in which optical signals of a plurality of wavelengths are multiplexed by spatial multiplexing, wavelength division multiplexing, or a combination thereof. The optical fiber communication system 200 corresponds to the communication system 10 illustrated in FIG. 1.

The optical fiber communication system 200 includes a plurality of optical transmitters 210, a multiplexer 220, a transmission path 230, a demultiplexer 240, and a plurality of optical receivers 250. The optical fiber communication system 200 constitutes, for example, a land metro communication system or an optical submarine cable system.

The optical transmitter 210 converts a plurality of pieces of transmission data into a polarization-multiplexed signal. The optical transmitter 210 generates, for example, a polarization multiplexed signal in which four series of signals of in-phase (I) components and quadrature (Q) components of the X polarized wave and the Y polarized wave are multiplexed. The optical transmitter 210 typically includes a modulator for modulating the CW light output from the laser diode according to four series of analog electrical signals, and generating a polarization multiplexed optical signal such as a polarization multiplexed quadrature-amplitude modulation (QAM) signal. The optical transmitter 210 is also referred to as a Tx. The optical transmitter 210 corresponds to the transmitter 11 illustrated in FIG. 1.

The multiplexer 220 multiplexes a plurality of polarization multiplexed signals output from the plurality of optical transmitters 210. The transmission path 230 transmits the optical signal output from the multiplexer 220 to the optical receiver 250. The transmission path 230 corresponds to the transmission path 13 illustrated in FIG. 1.

The transmission path 230 includes an optical fiber cable 232 and an optical amplifier 231. The optical fiber cable 232 includes one or more optical fibers that guide the optical signal transmitted from the optical transmitter 210. The optical amplifier 231 amplifies the optical signal and compensates for a propagation loss in the optical fiber cable 232. The optical amplifier 133 is configured as, for example, an erbium doped fiber amplifier (EDFA). The optical fiber cable 232 includes the weakly-coupled multicore fiber 190 illustrated in FIG. 2. The plurality of cores included in the weakly-coupled multicore fiber 190 may be used to transmit main signals.

In the optical fiber communication system 200, the first light source 171 outputs a first monitoring signal having a wavelength different from a wavelength of a main signal, that is, an optical signal output from the plurality of optical transmitters 210. In the transmission path 230, the first monitoring signal is inserted into the first core 191 of the weakly-coupled multicore fiber 190 included in the optical fiber cable 232 by using a device such as a FIFO device.

Similarly, the second light source 172 outputs a second monitoring signal having a wavelength different from that of the main signal. In the transmission path 230, the second monitoring signal is inserted into the second core 192 of the weakly-coupled multicore fiber 190 by using a device such as a FIFO device. At least one of the first monitoring signal and the second monitoring signal may be an Optical Supervisory Channel (OSC) signal used for operation setting in the transmission path and state monitoring of the transmission path.

In the transmission path 230, the first monitoring signal is selectively branched from the first core 191 of the weakly-coupled multicore fiber 190 included in the optical fiber cable 232 to the polarization characteristic measurement unit 111 by using a splitter such as a wavelength demultiplexer or a wavelength selection switch. In addition, the second monitoring signal is selectively branched from the second core 192 of the weakly-coupled multicore fiber 190 included in the optical fiber cable 232 to the polarization characteristic measurement unit 111 by using a splitter.

The demultiplexer 240 demultiplexes the polarization multiplexed signal multiplexed in the transmission path 230. The demultiplexer 240 outputs the plurality of polarization multiplexed signals to the plurality of optical receivers 250.

The optical receiver 250 receives the polarization multiplexed signal transmitted from the corresponding optical transmitter 210. The optical receiver 250 typically includes a polarization diversity type coherent receiver and a digital signal processing circuit for performing processing such as equalization processing on a received signal. The digital signal processing circuit includes, for example, a wavelength dispersion compensation filter, a carrier phase compensation filter, and a polarization fluctuation compensation filter. The optical receiver 250 is also referred to as Rx. The optical receiver 250 corresponds to the receiver 15 illustrated in FIG. 1.

FIG. 3 illustrates an example in which the optical fiber communication system 200 includes three optical transmitters 210 and three optical receivers 250, but the number of optical transmitters 210 and the number of optical receivers 250 are not limited to three. Although FIG. 3 illustrates an example in which the transmission path 230 includes two optical amplifiers 231, the number of optical amplifiers 231 in the transmission path 230 is not limited to two. Furthermore, the optical fiber communication system 200 may be configured as a communication system in which the main signal is bidirectionally transmitted in the optical fiber cable 232.

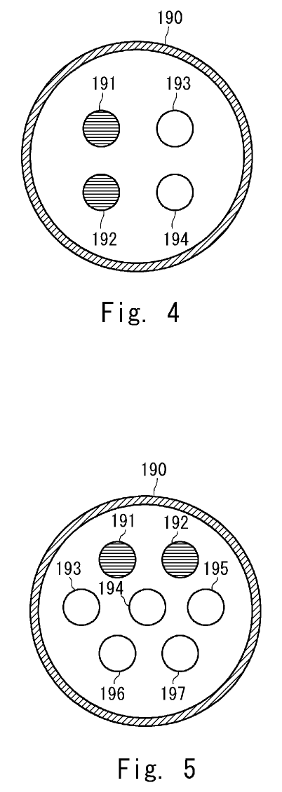

FIG. 4 is a cross-sectional view illustrating an example of a cross-sectional structure of the weakly-coupled multicore fiber 190. The weakly-coupled multicore fiber 190 is configured as a four-core weakly-coupled multicore fiber having four cores including a first core 191 and a second core 192 in a clad. In the weakly-coupled multicore fiber 190, the four cores 191 to 194 are each used to transmit a main signal transmitted from the optical transmitter 210. For example, the cores 191 and 193 are used to transmit the main signal in a first direction, and the cores 192 and 194 are used to transmit the main signal in a second direction. The first monitoring signal is superimposed on the main signal in the first core 191 that transmits the main signal in the first direction. Furthermore, the second monitoring signal is superimposed on the main signal in the second core 192 that transmits the main signal in the second direction.

FIG. 5 is a cross-sectional view illustrating another example of a cross-sectional structure of the weakly-coupled multicore fiber 190. In this example, the weakly-coupled multicore fiber 190 is configured as a four-core multicore fiber having seven cores including the first core 191 and the second core 192 in a cladding. For example, some cores including the first core 191 are used to transmit the main signal in the first direction, and some cores including the second core 192 are used to transmit the main signal in the second direction. The weakly-coupled multicore fiber 190 may be configured as a two-core optical fiber. In the weakly-coupled multicore fiber 190, at least one of the first core 191 and the second core 192 may be used to transmit only a monitoring signal.

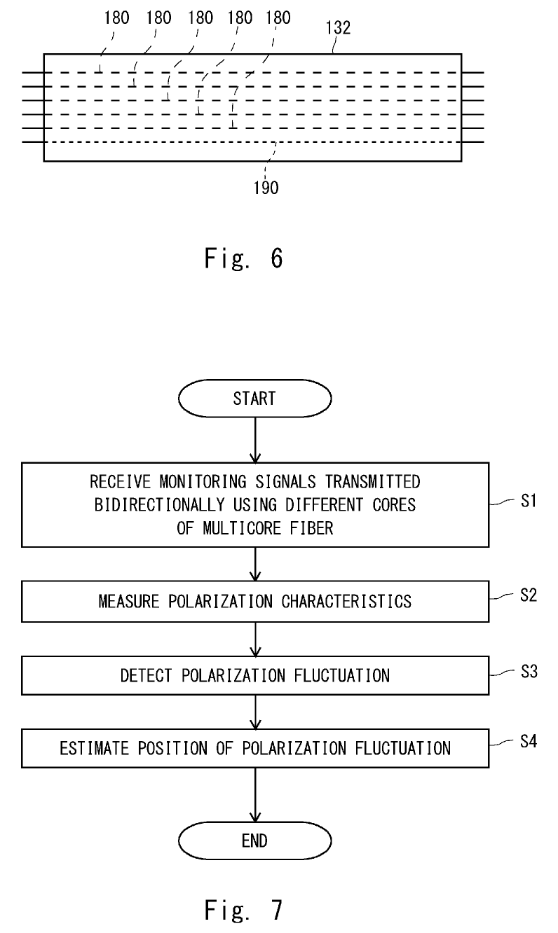

FIG. 6 is a block diagram illustrating a configuration example of the optical fiber cable 232. In the example of FIG. 6, the optical fiber cable 232 includes one or more optical fibers 180 and a weakly-coupled multicore fiber 190. The optical fiber 180 is used to transmit a main signal in the optical fiber communication system 200. The optical fiber 180 is configured as a single mode fiber. Alternatively, the optical fiber 180 is configured as a coupled multicore fiber having large crosstalk between cores. The coupled multicore fiber is also called a Randomly Coupled multicore fiber (MCF). The optical fiber cable 232 may include one or more single mode fibers and one or more coupled multi-fibers. The weakly-coupled multicore fiber 190 is used to transmit at least a first monitoring signal and a second monitoring signal.

Although FIG. 3 illustrates only one set of the light sources 171 and 172 and the polarization characteristic measurement units 111 and 112, the optical fiber communication system 200 may include a plurality of sets of the light sources 171 and 172 and the polarization characteristic measurement units 111 and 112. Stated another way, the optical fiber communication system 200 may have a plurality of sets of the polarization fluctuation monitoring system 100. For example, the optical fiber communication system 200 may include the polarization fluctuation monitoring system 100 for each span divided by the two optical amplifiers 231 in the transmission path 230.

Next, an operation procedure will be described. FIG. 7 is a flowchart illustrating an operation procedure of the polarization fluctuation monitoring apparatus 110. The operation procedure of the polarization fluctuation monitoring apparatus 110 is related to the polarization fluctuation monitoring method. The polarization fluctuation monitoring apparatus 110 receives a monitoring signal transmitted bidirectionally using different cores of the weakly-coupled multicore fiber 190 (step S1). In step S1, the first polarization characteristic measurement unit 111 receives the first monitoring signal transmitted in the first direction through the first core 191 of the weakly-coupled multicore fiber 190. Furthermore, the second polarization characteristic measurement unit 112 receives the second monitoring signal transmitted in the second direction through the second core 192 of the weakly-coupled multicore fiber 190.

The first polarization characteristic measurement unit 111 measures the polarization characteristics of the first monitoring signal, and the second polarization characteristic measurement unit 112 measures the polarization characteristics of the second monitoring signal (step S2). In step S2, the first polarization characteristic measurement unit 111 and the second polarization characteristic measurement unit 112 each calculates the Stokes parameter of the first monitoring signal and the second monitoring signal. The polarization fluctuation detection unit 113 detects the polarization fluctuation in each of the first monitoring signal and the second monitoring signal based on the polarization characteristics measured in step S2 (step S3). The polarization fluctuation position estimation unit 114 estimates the position where the polarization fluctuation occurred in the weakly-coupled multicore fiber 190 based on the polarization fluctuation detected in step S3 (step S4).

In the present example embodiment, the first and second monitoring signals are bidirectionally transmitted using the first core 191 and the second core 192 of one weakly-coupled multicore fiber 190. For example, in a case where an impact that causes polarization fluctuation is applied to the weakly-coupled multicore fiber 190, a change in the polarization state in the first monitoring signal due to the impact and a change in the polarization state in the second monitoring signal are considered to be the same. In addition, since the first core 191 and the second core 192 are cores included in one weakly-coupled multicore fiber 190, the transmission distance of the first monitoring signal and the transmission distance of the second monitoring signal are considered to be the same. In the present example embodiment, since the first monitoring signal and the second monitoring signal are transmitted in opposite directions, an influence of crosstalk between the first monitoring signal and the second monitoring signal is small.

Assume that different optical fibers are used for transmission of the first monitoring signal and the second monitoring signal. In that case, it is considered that a change in a different polarization state can be observed between the first monitoring signal and the second monitoring signal. In addition, in a case where separate optical fibers are used, the lengths of the two optical fibers are not limited to be the same, and it is considered that the transmission distance of the first monitoring signal and the transmission distance of the second monitoring signal may not be the same. In a case where the change in the polarization state observed between the first monitoring signal and the second monitoring signal is different, or in a case where the transmission distance of the first monitoring signal and the transmission distance of the second monitoring signal are not the same, the estimation accuracy of the position where the polarization fluctuation occurred is deteriorated. On the other hand, in the present example embodiment, since the monitoring signal transmitted bidirectionally through the two cores of the weakly-coupled multicore fiber is used, the polarization fluctuation position can be more accurately estimated as compared with the case where the two optical fibers are used.

If the distance between the two cores used for transmission of the first and second monitoring signals in the weakly-coupled multicore fiber 190 is short, it is considered that the same change in polarization characteristics is observed in the first and second monitoring signals. Therefore, if the first and second monitoring signals are transmitted using two adjacent cores in the weakly-coupled multicore fiber 190, it is considered that the position where the polarization fluctuation occurred can be estimated with high accuracy.

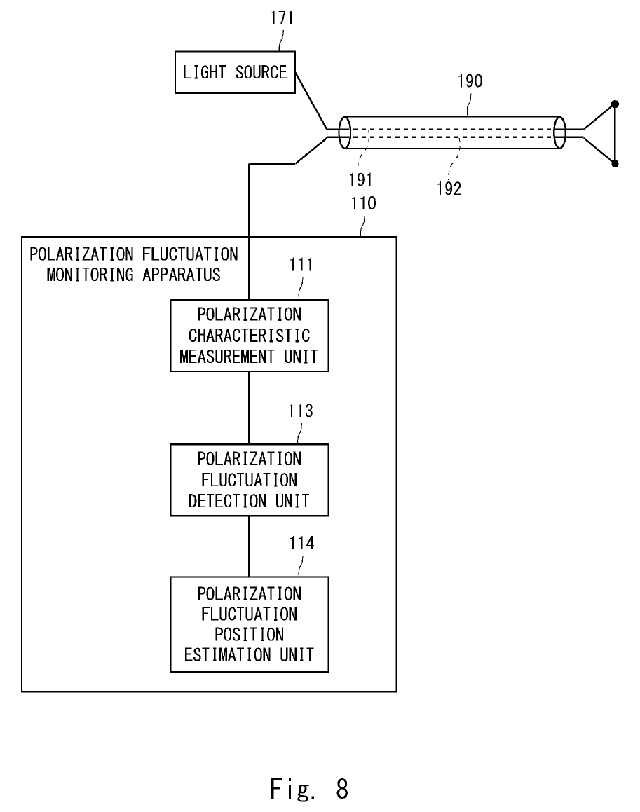

Next, a second example embodiment of the present disclosure will be described. FIG. 8 is a block diagram illustrating another configuration example of the polarization fluctuation monitoring system according to the present disclosure. A second example embodiment will be described with reference to FIG. 8. In the second example embodiment, the light source 171 inputs the monitoring signal from the first end portion of the weakly-coupled multicore fiber 190, and the polarization characteristic measurement unit 111 receives the monitoring signal reciprocated in the weakly-coupled multicore fiber 190 at the first end portion.

In the present example embodiment, the first monitoring signal output from the light source 171 is transmitted in the first direction from the first end portion toward the second end portion using the first core of the weakly-coupled multicore fiber 190. At the second end portion, the first monitoring signal is input to the second core 192 as a second monitoring signal using a device such as a FIFO device. The second monitoring signal is transmitted in the second direction from the second end portion toward the first end portion of the weakly-coupled multicore fiber 190.

In the present example embodiment, the monitoring signal output from the light source 171 is input to the first core 191 of the weakly-coupled multicore fiber 190 at the first end portion, folded back at the second end portion of the weakly-coupled multicore fiber 190, and input to the second core 192 at the second end portion. In the monitoring signal received by the polarization characteristic measurement unit 111, the first monitoring signal and the second monitoring signal can be distinguished by the received time. In the present example embodiment, the polarization fluctuation monitoring apparatus 110 can estimate the position where the polarization fluctuation occurred by measuring the polarization characteristics of the monitoring signal at one end portion of the weakly-coupled multicore fiber 190. Therefore, the configuration of the polarization fluctuation monitoring system 100a according to the present example embodiment can be simplified as compared with the polarization fluctuation monitoring system 100 according to the first example embodiment.

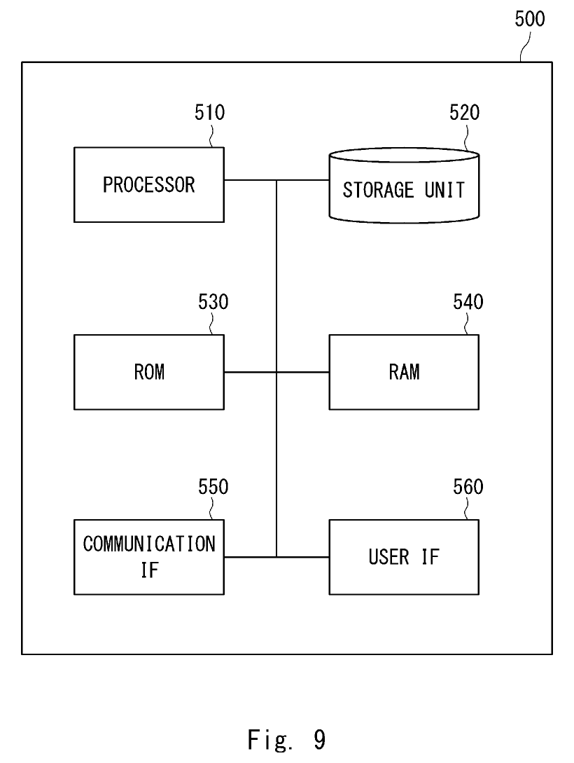

Next, an example of a physical configuration of the polarization fluctuation monitoring apparatus 110 will be described. FIG. 9 is a block diagram illustrating a configuration example of a computer device that can be used as a polarization fluctuation monitoring apparatus. A computer device 500 includes a processor 510 such as a Central Processing Unit (CPU), a storage unit 520, a Read Only Memory (ROM) 530, a Random Access Memory (RAM) 540, a communication interface (IF) 550, and a user interface 560.

The communication interface 550 is an interface connecting the computer device 500 to a communication network through wired communication means, wireless communication means, or the like. The user interface 560 includes, for example, a display unit such as a display. The user interface 560 includes an input unit such as a keyboard, a mouse, and a touch panel.

The storage unit 520 is an auxiliary storage device that can retain various types of data. The storage unit 520 is not necessarily a part of the computer device 500, and may be an external storage device or cloud storage connected to the computer device 500 via a network.

The ROM 530 is a nonvolatile storage device. For example, a semiconductor storage device such as a flash memory having a relatively compact capacity may be used for the ROM 530. A program to be executed by the processor 510 may be stored in the storage unit 520 or in the ROM 530. The storage unit 520 or the ROM 530 stores various programs for implementing, for example, the functions of the polarization fluctuation detection unit 113 and the polarization fluctuation position estimation unit 114 in the polarization fluctuation monitoring apparatus 110.

The program described above includes commands (or software codes) for causing a computer to implement one or more functions described in the example embodiment in a case of being read by the computer. The program may be stored in a non-transitory computer readable medium or a tangible storage medium. As an example and not by way of limitation, the computer-readable medium or the tangible storage medium includes a memory technology such as a RAM, a ROM, a flash memory, a solid-state drive (SSD) or the like, an optical disc storage such as a Compact Disc (CD), a digital versatile disc (DVD), a Blu-ray (registered trademark) disc or the like, and a magnetic storage device such as a magnetic cassette, a magnetic tape, a magnetic disk storage, or the like. The program may be transmitted through a transitory computer-readable medium or a communication medium. By way of example, and not limitation, transitory computer-readable medium or communication medium includes propagation signals of electrical, optical, acoustic, or a form different from electrical, optical, and acoustic.

The RAM 540 is a volatile storage device. Various semiconductor memory devices, such as a Dynamic Random Access Memory (DRAM), a Static Random Access Memory (SRAM), and the like are used for the RAM 540. The RAM 540 may be used as an internal buffer for temporarily storing data and the like. The processor 510 loads a program stored in the storage unit 520 or the ROM 530 into the RAM 540, and executes the loaded program. Once the processor 510 executes the program, the functions of the polarization fluctuation detection unit 113 and the polarization fluctuation position estimation unit 114 can be implemented in the polarization fluctuation monitoring apparatus 110. The processor 510 may include an internal buffer that may temporarily store data and the like.

In the present disclosure, the polarization fluctuation monitoring apparatus 110 is not necessarily configured as a single apparatus. The polarization fluctuation monitoring apparatus 110 may be configured using a plurality of physically separated apparatuses. For example, in the configuration illustrated in FIG. 2, the polarization characteristic measurement units 111 and 112 are not necessarily arranged in a single apparatus. For example, the first polarization characteristic measurement unit 111 may be disposed at the first end portion of the weakly-coupled multicore fiber 190, and the second polarization characteristic measurement unit 112 may be disposed at the second end portion of the weakly-coupled multicore fiber 190. Furthermore, the polarization fluctuation detection unit 113 and the polarization fluctuation position estimation unit 114 are not necessarily arranged in a single apparatus. The polarization fluctuation detection unit 113 and the polarization fluctuation position estimation unit 114 may be disposed in separate apparatuses.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely illustrative for describing one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps illustrated in any of the drawings may be changed as appropriate.

Some or all of the above-described example embodiments may also be described as the following supplementary notes, but are not limited to the following supplementary notes.

### Supplementary Note 1

A polarization fluctuation monitoring apparatus including

a polarization characteristic measurement unit for measuring polarization characteristics of a first monitoring signal transmitted in a first direction using a first core and a second monitoring signal transmitted in a second direction opposite to the first direction using a second core in a transmission path including a weakly-coupled multicore fiber including the first core and the second core,

a fluctuation detection unit for detecting polarization fluctuation occurring in each of the first monitoring signal and the second monitoring signal in the weakly-coupled multicore fiber based on the measured polarization characteristics, and

a position estimation unit for estimating a position where the polarization fluctuation occurred in the transmission path based on the detected polarization fluctuation.

### Supplementary Note 2

The polarization fluctuation monitoring apparatus according to supplementary note 1, in which the fluctuation detection unit detects a first polarization fluctuation that occurred in the transmission path while the first monitoring signal is being transmitted in the first direction and a second polarization fluctuation that occurred in the transmission path while the second monitoring signal is being transmitted in the second direction.

### Supplementary Note 3

The polarization fluctuation monitoring apparatus according to supplementary note 2, further including a position estimation unit for estimating a position where the polarization fluctuation occurred in the transmission path based on a time difference between a time at which the first polarization fluctuation is detected and a time at which the second polarization fluctuation is detected.

### Supplementary Note 4

The polarization fluctuation monitoring apparatus according to any one of supplementary notes 1 to 3, in which the polarization characteristic measurement unit includes a first polarization characteristic measurement unit for measuring polarization characteristics of the first monitoring signal at a first end portion of the transmission path, and a second polarization characteristic measurement unit for measuring polarization characteristics of the second monitoring signal at a second end portion of the transmission path on the opposite side of the first end portion.

### Supplementary Note 5

The polarization fluctuation monitoring apparatus according to any one of supplementary notes 1 to 3, in which the first monitoring signal is transmitted in the first direction from a first end portion toward a second end portion of the weakly-coupled multicore fiber, is input to the second core at the second end portion, and is transmitted in the second direction from the second end portion toward the first end portion as the second monitoring signal.

### Supplementary Note 6

The polarization fluctuation monitoring apparatus according to any one of supplementary notes 1 to 5, in which the first monitoring signal is superimposed on a first main signal transmitted in the first direction through the first core, and the second monitoring signal is superimposed on a second main signal transmitted in the second direction through the second core.

### Supplementary Note 7

The polarization fluctuation monitoring apparatus according to any one of supplementary notes 1 to 6, in which the transmission path further includes at least one of one or more multicore fibers or one or more single-mode fibers for transmitting a main signal.

### Supplementary Note 8

The polarization fluctuation monitoring apparatus according to any one of supplementary notes 1 to 7, in which the one or more multicore fibers are coupled multicore fibers.

### Supplementary Note 9

A communication system including

one or more transmitters, each of which transmits a main signal,

a transmission path for transmitting one or more main signals transmitted from the one or more transmitters,

optical receivers, each of which receives the one or more main signals transmitted through the transmission path, and

a polarization fluctuation monitoring apparatus for monitoring a polarization fluctuation in the transmission path, in which

the transmission path includes a weakly-coupled multicore fiber including a first core and a second core, and

the polarization fluctuation monitoring apparatus includes

a polarization characteristic measurement unit for measuring polarization characteristics of a first monitoring signal transmitted in a first direction using the first core and a second monitoring signal transmitted in a second direction opposite to the first direction using the second core in the transmission path,

a fluctuation detection unit for detecting polarization fluctuation occurring in the weakly-coupled multicore fiber based on the measured polarization characteristics, and

a position estimation unit for estimating a position where the polarization fluctuation occurred in the transmission path based on the detected polarization fluctuation.

### Supplementary Note 10

A polarization fluctuation monitoring method including

measuring polarization characteristics of a first monitoring signal transmitted in a first direction using a first core and a second monitoring signal transmitted in a second direction opposite to the first direction using a second core in a transmission path including a weakly-coupled multicore fiber including the first core and the second core,

detecting polarization fluctuation occurring in the weakly-coupled multicore fiber based on the measured polarization characteristics, and

estimating a position where the polarization fluctuation occurred in the transmission path based on the detected polarization fluctuation.

Some or all of the elements (e.g., components and functions) described in Supplementary Notes 2 to 8 dependent on Supplementary Note 1 may be dependent on Supplementary Notes 9 and 10 as well with similar dependent relationships to those of Supplementary Notes 2 to 8. Some or all of the elements described in any supplementary note may be applied to various types of hardware, software, recording means for recording software, systems, and methods.

1. A polarization fluctuation monitoring apparatus comprising:
a polarization characteristic measurement instrument configured to measure polarization characteristics of a first monitoring signal transmitted in a first direction using a first core and a second monitoring signal transmitted in a second direction opposite to the first direction using a second core in a transmission path including a weakly-coupled multicore fiber including the first core and the second core;
at least one memory storing instructions; and
at least one processor configured to execute the instructions to:
detect polarization fluctuation occurring in each of the first monitoring signal and the second monitoring signal in the weakly-coupled multicore fiber based on the measured polarization characteristics; and
estimate a position where the polarization fluctuation occurred in the transmission path based on the detected polarization fluctuation.

2. The polarization fluctuation monitoring apparatus according to claim 1, wherein the at least one processor is configured to execute the instructions to detect a first polarization fluctuation that occurred in the transmission path while the first monitoring signal is being transmitted in the first direction and a second polarization fluctuation that occurred in the transmission path while the second monitoring signal is being transmitted in the second direction.

3. The polarization fluctuation monitoring apparatus according to claim 2, wherein the at least one processor is configured to execute the instructions to estimate a position where the polarization fluctuation occurred in the transmission path based on a time difference between a time at which the first polarization fluctuation is detected and a time at which the second polarization fluctuation is detected.

4. The polarization fluctuation monitoring apparatus according to claim 1, wherein the polarization characteristic measurement instrument includes a first polarization characteristic measurement instrument configured to measure polarization characteristics of the first monitoring signal at a first end portion of the transmission path, and a second polarization characteristic measurement instrument configured to measure polarization characteristics of the second monitoring signal at a second end portion of the transmission path on the opposite side of the first end portion.

5. The polarization fluctuation monitoring apparatus according to claim 1, wherein the first monitoring signal is transmitted in the first direction from a first end portion toward a second end portion of the weakly-coupled multicore fiber, is input to the second core at the second end portion, and is transmitted in the second direction from the second end portion toward the first end portion as the second monitoring signal.

6. The polarization fluctuation monitoring apparatus according to claim 1, wherein the first monitoring signal is superimposed on a first main signal transmitted in the first direction through the first core, and the second monitoring signal is superimposed on a second main signal transmitted in the second direction through the second core.

7. The polarization fluctuation monitoring apparatus according to claim 1, wherein the transmission path further includes at least one of one or more multicore fibers or one or more single-mode fibers for transmitting a main signal.

8. The polarization fluctuation monitoring apparatus according to claim 7, wherein the one or more multicore fibers are coupled multicore fibers.

9. A communication system comprising:
one or more transmitters, each of which transmits a main signal;
a transmission path for transmitting one or more main signals transmitted from the one or more transmitters;
optical receivers, each of which receives the one or more main signals transmitted through the transmission path; and
a polarization fluctuation monitoring apparatus for monitoring a polarization fluctuation in the transmission path, wherein
the transmission path includes a weakly-coupled multicore fiber including a first core and a second core, and
the polarization fluctuation monitoring apparatus includes:
a polarization characteristic measurement instrument for measuring polarization characteristics of a first monitoring signal transmitted in a first direction using the first core and a second monitoring signal transmitted in a second direction opposite to the first direction using the second core in the transmission path;
at least one memory storing instructions; and
at least one processor configured to execute the instructions to: detect polarization fluctuation occurring in the weakly-coupled multicore fiber based on the measured polarization characteristics; and
estimate a position where the polarization fluctuation occurred in the transmission path based on the detected polarization fluctuation.

10. A polarization fluctuation monitoring method comprising:
measuring polarization characteristics of a first monitoring signal transmitted in a first direction using a first core and a second monitoring signal transmitted in a second direction opposite to the first direction using a second core in a transmission path including a weakly-coupled multicore fiber including the first core and the second core;
detecting polarization fluctuation occurring in the weakly-coupled multicore fiber based on the measured polarization characteristics; and
estimating a position where the polarization fluctuation occurred in the transmission path based on the detected polarization fluctuation.
